(19) United States
(12) Patent Application Publication
(10) Pub. No.: US 2026/0148133 A1
(43) Pub. Date: May 28, 2026

(54) METHOD AND SYSTEM FOR ANOMALY DETECTION, HEALTH INDEX CLASSIFICATION, AND REMAINING USEFUL LIFE (RUL) PREDICTION OF CIRCUIT BREAKERS

(71) Applicants: Centre for Advances in Reliability and Safety Limited, Pak Shek Kok (HK); The Hong Kong Polytechnic University, Hung Hom (HK)

(72) Inventors: Siqi BU, Hung Hom (HK); Pui Yu LIN, Pak Shek Kok (HK); Him Ching YEUNG, Pak Shek Kok (HK); Genghong LU, Pak Shek Kok (HK); Yicheng FU, Pak Shek Kok (HK); Bingsen WANG, Pak Shek Kok (HK); Yihua DAN, Pak Shek Kok (HK); Chak Nam WONG, Pak Shek Kok (HK); Kin Man LAM, Pak Shek Kok (HK)

(21) Appl. No.: 19/058,994

(22) Filed: Feb. 20, 2025

(30) Foreign Application Priority Data
Nov. 28, 2024 (HK) 32024100182.7

(51) Int. Cl. G06N 20/00

(52) U.S. Cl. CPC G06N 20/00

(57) ABSTRACT

Disclosed is a method for anomaly detection, health index classification, and remaining useful life (RUL) prediction of circuit breakers, including the steps of: capturing and collecting real-time trip coil waveform signals from each of circuit breakers; transmitting the collected trip coil waveform signals to a circuit breaker health monitoring system; processing the collected signals data; analyzing the processed data using artificial intelligence and signal processing algorithms for anomaly detection, health index classification, and remaining useful life (RUL) prediction; storing data; performing trend analysis on data; and predicting remaining useful life (RUL).

### CROSS-REFERENCE TO RELATED APPLICATIONS

Not applicable.

### FIELD OF THE INVENTION

The present invention relates to a field anomaly detection of circuit breakers, and more particularly, to a method and system for anomaly detection, health index classification, and remaining useful life (RUL) prediction of circuit breakers.

### BACKGROUND OF THE INVENTION

A power system is essential for modern society, as it provides the electricity that powers homes, businesses, hospitals, factories, and other critical infrastructure. It plays a critical role in supporting economic growth, public health, and quality of life. A reliable and resilient power system is therefore essential for the functioning of modern society.

Power supply interruptions incur significant financial losses to utilities and their customers as well as disturbance to basic operation of society. Most of the interruptions arise from failure of components in power distribution system and it is therefore equipped with protection systems to detect faults within the network arising from component failures, and to isolate the faulty section from the rest of the network to minimize the consequences of fault. Among the wide spectrum of protection systems, circuit breaker is a widely used device to protect the system against failure of components and disturbances in the system, arising from overcurrent or overload or short circuit.

Preventive maintenance and inspection activities for circuit breakers have been an effective way to monitor the health of circuit breakers and to help ensure their reliable operation. Most of them have historically been performed on a periodic basis by time-based maintenance in accordance with manufacturers' instructions and industry standards. Lack of maintenance could result in longer clearing times with unintentional time-delay under fault conditions, resulting in extensive damage to the electrical equipment, as well as creating a greater arc flash hazard.

However, this maintenance work could be very expensive with more frequent and comprehensive tests and inspections. It becomes a burden on the operation and maintenance budgets as well as time-consuming for engineers to successfully manage. As the maintenance interval is determined irrespective of the condition of circuit breakers, it is possible that a part may experience a serious problem prior to the next maintenance. Therefore, this might result in high cost for the maintenance work but without any reliability improvement in some cases.

Some of these examples are discussed in the following prior arts.

Korea patent publication no. 20220011052A discloses a method for failure detection of circuit breaker and apparatus for performing the same. The circuit breaker failure diagnosis method includes the steps of: receiving circuit breaker data of a circuit breaker, by a circuit breaker management server; determining, by the circuit breaker management server, a circuit breaker data group of breaker data; determining the health factor of the circuit breaker considering the circuit breaker data group, by the circuit breaker management server; and determining the state of the circuit breaker based on the health factor, by the circuit breaker management server. Unsupervised learning based on anomaly detection is performed in the prior art. Although it is unsupervised based on anomaly detection can identifies anomalies across the entire waveform, it only supports binary classification, which is insufficient for multi-level health index classification.

China patent publication no. 107219457B discloses frame-type circuit breaker fault diagnosis and degree assessment method based on operation attachment electric current. This method first determines whether the working stage wait diagnose and assess breaker, the working stage includes energy storage stage, combined floodgate stage and separating brake stage, then carries out fault diagnosis to energy storage stage using energy storage motor electric current, carries out fault diagnosis and scale evaluation to the stage of combined floodgate using closing coil electric current and carries out fault diagnosis and scale evaluation to the separating brake stage using opening coil electric current. Energy storage motor current signal of the detection block pantograph disconnecting switch in energy storage stage, the closing coil current signal in the combined floodgate stage and the opening coil current signal in the separating brake stage respectively, fault diagnosis is carried out in combination with multi-kernel support vector machine, when diagnosis be out of order need to carry out fault degree assessment when, the judgement of fault degree can be accurately carried out by fault degree characteristic curve. However, the application of multi-kernel support vector machine that is known as traditional support vector machine (SVM) may have limited performance when dealing with highly unbalanced data. The biased toward majority class in the unbalanced data may lead poor performance on the minority class.

China patent publication no. 109270442B discloses a DBN-GA neural network-based high-voltage circuit breaker fault detection method, which specifically comprises the following steps: taking current data monitored by an online monitoring system as an input variable; then, a fault type prediction model is built by utilizing a deep learning algorithm based on a deep belief neural network, a restricted Boltzmann machine model is determined and marked as RBM, and a part of current data samples are extracted to build the model and are trained; after the limited Boltzmann machine is trained, the whole deep belief neural network model is trained and learned; and finally, inputting all data into a trained fault type prediction model, and processing the input opening and closing coil current data by the fault type prediction model to finish the fault detection of the high-voltage circuit breaker. The method is merely predicts and detects type of fault on the circuit breaker, without estimates as to when the failure will occur.

Therefore, there still remains a need in the field to provide a solution that solves the problems described herein.

### SUMMARY OF THE INVENTION

It is an objective of the present invention to provide a method and system that performs anomaly detection and health index classification for circuit breakers in power distribution systems by applying signal processing techniques combined with an unsupervised machine learning approach to analyze the tripping coil current waveform of circuit breakers to achieve better performance in dealing with unbalanced datasets.

It is also an objective of the present invention to provide a method and system that could perform multi-level health index classification with high accuracy.

It is further an objective of the present invention to provide a computation method and system that is simple, accurate, and efficient for predicting the remaining useful life (RUL) of circuit breakers, which helps optimize maintenance schedules and reduce operational costs.

It is further an objective of the present invention to provide a cloud-based online health monitoring system that can centralize data, which allows user to oversee the current and past performance of all circuit breakers in the network and automatically provide early warnings when anomalies or poor health condition are detected, whilst maintaining a reliable and safe power supply network.

Accordingly, these objectives may be achieved by following the teachings of the present invention. The present invention relates to a method for anomaly detection, health index classification, and remaining useful life (RUL) prediction of circuit breakers, comprising the steps of: capturing and collecting real-time trip coil waveform signals from each of circuit breakers; transmitting the collected trip coil waveform signals to a circuit breaker health monitoring system; processing the collected signals data; analyzing the processed data using artificial intelligence and signal processing algorithms for anomaly detection, health index classification, and remaining useful life (RUL) prediction; storing data; performing trend analysis on data; and predicting remaining useful life (RUL).

### BRIEF DESCRIPTION OF DRAWINGS

The features of the invention will be more readily understood and appreciated from the following detailed description when read in conjunction with the accompanying drawings of the preferred embodiment of the present invention.

FIG. 1 illustrates an operation environment of the system in the present invention.

FIGS. 2A-2F illustrate circuit breakers with spring-operated mechanism going through an open switching operation.

FIG. 3 illustrates an example of typical captured trip coil current profile.

FIG. 4 illustrates a diagram of health criteria with the prediction of remaining useful life.

FIG. 5 illustrates an example method flowchart of detecting anomalies for circuit breaker system in the present invention.

### DETAILED DESCRIPTION OF THE INVENTION

For the purposes of promoting and understanding of the principles of the invention, reference will now be made to the embodiments illustrated in the drawings and described in the following written specification. It is understood that the present invention includes any alterations and modifications to the illustrated embodiments and includes further applications of the principles of the invention as would normally occur to one skilled in the art to which the invention pertains.

The present invention teaches a method for anomaly detection, health index classification, and remaining useful life (RUL) prediction of circuit breakers 104, comprising the steps of: capturing and collecting real-time trip coil 206 waveform signals from each of circuit breakers 104; transmitting the collected trip coil 206 waveform signals to a circuit breaker health monitoring system 108; processing the collected data; analyzing the processed data using artificial intelligence 110 and signal processing algorithms 112 for anomaly detection, health index classification, and remaining useful life (RUL) prediction of circuit breakers; and storing data; performing trend analysis on data; and predicting remaining useful life (RUL).

In accordance with a preferred embodiment of the present invention, the analyzing of the processed data using artificial intelligence 110 comprises the steps of: training and developing an unsupervised machine learning model using trip coil 206 waveforms of the circuit breakers 104; and identifying anomalies in waveforms.

In accordance with a preferred embodiment of the present invention, the analyzing of the processed data using signal processing algorithms 112 comprises the steps of: filtering and smoothing signal; and extracting features for health criteria calculation.

In accordance with a preferred embodiment of the present invention, the artificial intelligence method further comprises the steps of: providing simultaneous multi-level health index classification; and automatically sending an alert message to user 510 when an anomaly of a circuit breaker 104 is detected for facilitating prompt follow-up actions.

In accordance with a preferred embodiment of the present invention, the identifying of anomalies in waveforms comprises the steps of: recording result as historical data for trend analysis 512 of the circuit breakers 104; setting the threshold for end of life (EOL); and predicting remaining useful life (RUL) of circuit breakers 104.

In accordance with a preferred embodiment of the present invention, the method further comprises the step of: online monitoring and centralizing the collected signals data, data analysis and data storage in the circuit breaker health monitoring system 108. The method further comprises the step of storing data in a server, including but not limited to a local or cloud server.

In accordance with a preferred embodiment of the present invention, the method further comprises the step of: communicating with other data sources, including but not limited to an event log server 120 for determining the identity (ID) of the circuit breaker 104 associated with diagnosed signals.

The present invention also teaches a circuit breaker diagnosis system, comprising of: a power distribution system 102 with circuit breakers 104 that is deployed with: a data acquisition module configured to collect real-time trip coil 206 waveform signals from each of the circuit breakers 104; a processing module; a monitoring module, deployed with an artificial intelligence 110 and signal processing algorithms 112; and a storage module 114.

In accordance with a preferred embodiment of the present invention, the data acquisition module comprises trip coil waveform data capture system 106. The trip coil 206 waveform data capture system 106 comprises current probes, oscilloscopes, and microcontrollers.

In accordance with a preferred embodiment of the present invention, the monitoring module comprises circuit breaker health monitoring system 108 that is configured to perform data analysis and data storage. The circuit breaker health monitoring system 108 is a cloud-based, online and centralized system that is configured to monitor the health and performance of circuit breakers 104 located in various locations and enable real-time data transmission to the cloud. This is beneficial in allowing user to manage tens of thousands of circuit breakers 104 across multiple locations using a single website.

In accordance with a preferred embodiment of the present invention, the artificial intelligence 110 comprises unsupervised machine learning models. The unsupervised machine learning model is developed and trained using the entire trip coil 206 waveforms of the circuit breakers 104 to identify anomalies in waveforms.

In accordance with a preferred embodiment of the present invention, the signal processing algorithms 112 are configured to analyze the features of the trip coil 206 current waveforms, diagnose the health conditions of circuit breakers 104 and determine the health criteria of circuit breakers 104.

In accordance with a preferred embodiment of the present invention, the storage module 114 is configured to record result as historical data for trend analysis 512.

In accordance with a preferred embodiment of the present invention, the system is configured to predict remaining useful life (RUL) of the circuit breakers 104.

### Example

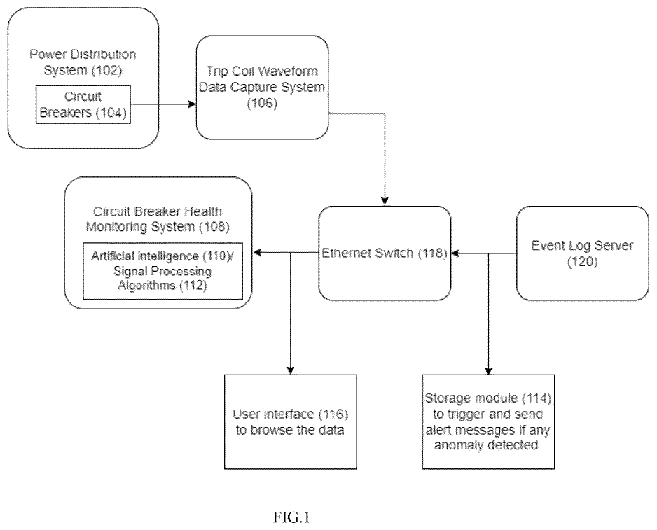

FIG. 1 illustrates an operation environment of the system in the present invention. The system includes a power circuit or power distribution system 102 in which a circuit breaker 104 is installed as the protection system, and it would trip to isolate the faulty section from the rest of the network when there is overcurrent, overload or short circuit. The system also includes a trip coil waveform data capture system 106 that acts as a data acquisition module that includes, but not limited to, current probes, oscilloscopes, and microcontrollers. These components are configured to collect real-time trip coil 206 waveform signals from all circuit breakers 104.

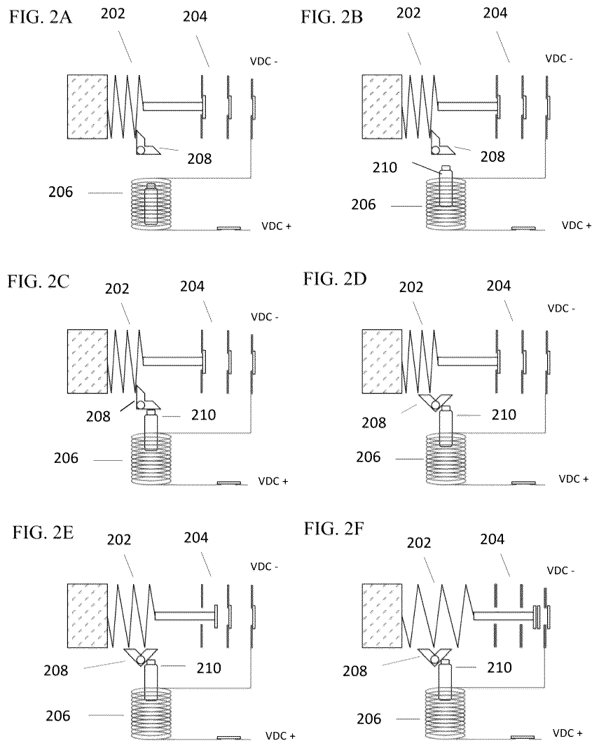

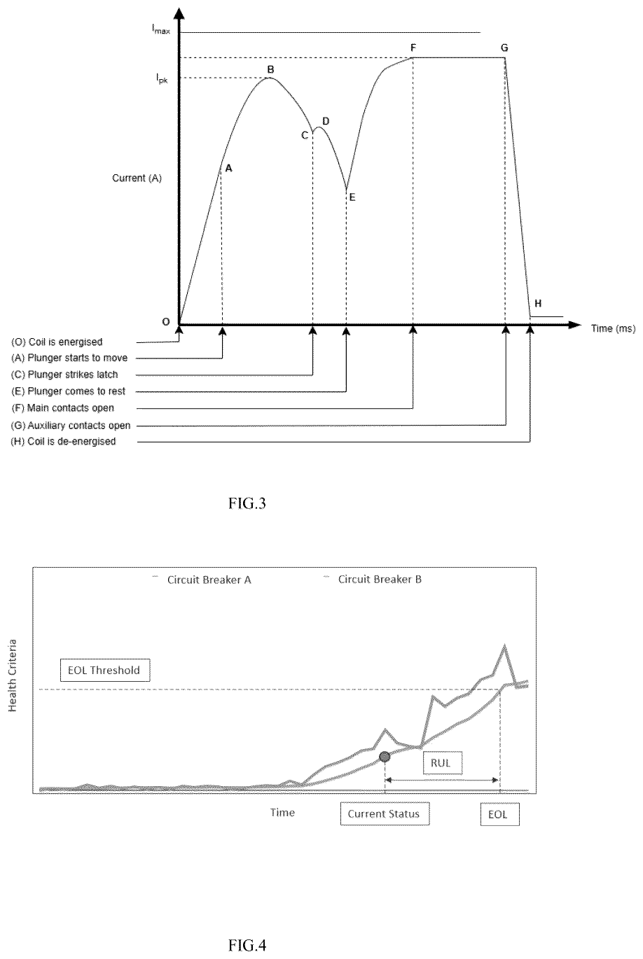

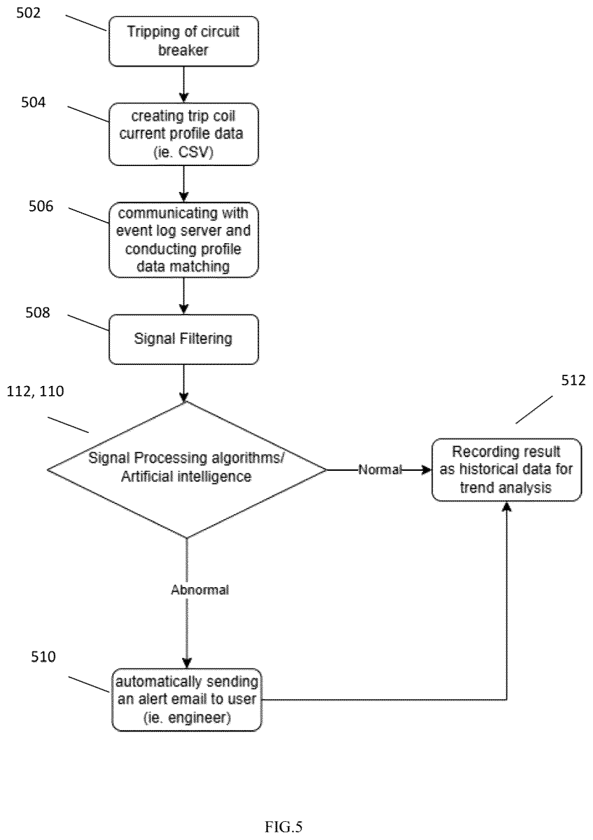

The trip coil waveform data capture system 106 sends the collected signals to the monitoring module, also known as the circuit breaker health monitoring system 108 in the present invention, which also acts as a server for data storage and data analysis by the artificial intelligence 110 and signal processing algorithms 112 installed. The trip coil 206 current waveforms of circuit breakers 104 are used as the diagnostic signals in the present invention for monitoring the health conditions of circuit breakers 104 in real-time. The behavior of the trip coil 206 current is directly impacted by the actuator system of the coil of the circuit breaker 104. By capturing and analyzing the circuit breakers's 104 trip coil 206 current profiles from open and close operations of circuit breakers 104, it is possible to initiate predictive maintenance alarms for circuit breakers 104. The specifics of the mechanism of the circuit breaker 104 vary between manufacturers and a generalized illustration of a circuit breaker 104 with a spring-operated mechanism going through an open switching operation is shown in FIG. 2A-F, while the typical captured trip coil 206 current profile is shown in FIG. 3.

When the trip coil 206 is energized, current rises causing a magnetic field to apply on an iron plunger 210. The plunger 210 begins to move at “A” when the force on the plunger 210 exceeds the stiction as shown in FIG. 3. Its motion induces an e.m.f. in the coil by reducing the current flowing through it. The current reaches the first peak Iₚₖ at “B” and then falls until the plunger 210 strikes the latch 208 mechanism at “C”, where a sudden reduction in the velocity results in a “corner” in the current profile. The combined mass of the plunger 210 and the latch 208 reduces the plunger's 210 momentum, causing further reduction in the coil current from “D” to “E” until it hits a buffer, bringing it to rest. Then the latch 208 unlocks the spring 202 operating mechanism to open the main contacts 204 at “G”. Meanwhile, the current increases to the maximum Imax at “F” until the main contacts 204 are opened while the plunger 210 is at rest. The current would drop significantly at “H” when the main contacts 204 are opened.

All these feature points are regarded as events. Each event has an expected value range and relation to the others. Outliers can be used to identify potential problems with the mechanism. For example, if the times for “A” and “B” are as expected but that for “C” and all subsequent events are delayed, it can be inferred that the problem is with the latch 208. Domain knowledge can help identify likely scenarios, such as poor lubrication causing the latch 208 to become overly stiff.

As further illustrated in FIG. 1, the signal processing algorithms 112 are configured to analyze the features of the trip coil 206 current waveform, diagnose the health conditions of circuit breakers 104, and determine the health criteria of circuit breakers 104. The trip coil 206 current signals of each circuit breaker 104 are collected by the trip coil waveform data capture system 106, which would then send them to the circuit breaker health monitoring system 108 for analysis. The circuit breaker health monitoring system 108 first handles the input signals by signal processing techniques that involve signal filtering 508, signal smoothing, and feature extraction. Feature extraction based on peak and valley detection on the processed signal is then applied to obtain features such as T_{B}, T_{E}, T_{F}, T_{H}, I_{B} and I_{F} as stated in FIG. 3 for health index classification.

The signals are also analyzed by a machine learning algorithm. For anomaly detection, as anomalous cases are rare and the percentage of anomalies in the dataset is small, the dataset is highly unbalanced. The performance of supervised machine learning models on highly unbalanced datasets is often limited. In contrast, unsupervised machine learning models for anomaly detection do not rely on labeled data to find patterns or clusters in the data. These models are trained on a dataset that contains mostly normal samples and, therefore, output a small error when predicting normal data and a large error when predicting abnormal data. The unsupervised machine learning model for anomaly detection can always achieve much higher performance compared to the supervised one when the dataset is highly unbalanced, with a drawback of supporting binary classification only. Therefore, the machine learning algorithm in the present invention is built based on an unsupervised machine learning approach. The entire trip coil waveforms of the circuit breakers 104 are used to train and develop the machine learning model, which can then identify any anomalies in waveforms.

Further, unsupervised machine learning in the present invention can achieve higher accuracy as it identifies anomalies across the entire waveform, compared to signal processing methods that only detect anomalies at certain feature points. However, it only supports binary classification, which is insufficient for multi-level health index classification. Therefore, the present invention combines signal processing-based health criteria with unsupervised machine learning, which not only can diagnose the health condition of circuit breakers 104 and determine the health index classification criteria, but it also can achieve simultaneous multi-level classification with high accuracy.

In addition to the machine learning output and signal processing-detected feature points, other domain data such as circuit breaker 104 aging and maintenance times are also included in the health criteria. It includes, but not limited to, T_{B}, T_{E}, T_{F}, T_{H}, I_{B}, I_{F}, Age, n_{maintenance} and Rₗₒₛₛ.

The Health Criteria H (signal processing based) is set in equation (1) below:

$$H = \frac{{T}_{E}}{{p}_{1}} \times {ω}_{1} + \frac{{T}_{H}}{{p}_{2}} \times {ω}_{2} + \frac{2}{{I}_{B}} \times {ω}_{3} [ + \frac{Age}{{p}_{4}} \times {ω}_{4} + \frac{{n}_{maintenance}}{{p}_{5}} \times {ω}_{5} + \frac{{R}_{loss}}{{p}_{6}} \times {ω}_{6} + … ( any other key factors ) ] \qquad ( 1 )$$

where:
   T_{E}: Time to point E in FIG. 5 (weighting: ω₁, time constant: p₁)
   T_{H}: Time to point H in FIG. 5 (weighting: ω₂, time constant: p₂)
   I_{B}: Magnitude of point B (weighting: ω₃)
   Age: Age of circuit breaker (weighting: ω₄, age constant: p₄)
   n__{maintenance}: Total number of maintenance work taken (weighting: ω₅, constant: p₅)
   Rₗₒₛₛ: Machine learning output, reconstruction loss (weighting: ω₆, constant: p₅)

The health criteria can be classified into n classes, where n can be any number. n=3 is used here as an example. For n=3, the health criteria are divided into 3 ranges:

$$H <= c\_ 1 \qquad range 1$$

$$c\_ 1 < H <= c\_ 2 \qquad range 2$$

$$H > c\_ 2 \qquad range 3$$

The constants c₁ and c₂ are determined based on statistical analysis of the calculated Health Criteria H of the real trip coil 206 current waveform dataset and the circuit breaker 104 real health condition provided by a local power supply company. In one scenario, the c₁ and c₂ are 1 and 1.6, respectively. The health index (HI) is determined by the machine learning results and the health criteria range in Table 1.

TABLE 1
Range of health criteria

| | | |
|---|---|---|
| HI Class 1 | Machine learning model detected normal + | Normal |
| | health criteria in range 1 | |
| HI Class 2 | Machine learning model detected abnormal + | Special |
| | health criteria in range 2 | attention |
| HI Class 3 | Machine learning model detected abnormal + | Danger |
| | health criteria in range 3 | |

A circuit breaker 104 would be classified as Class 1 if it is diagnosed as “Normal” by the machine learning algorithm and the Health Criteria H is smaller than c₁ (for n=3). If the machine learning algorithm diagnoses the CB as “abnormal”, they will be classified as Class 2 or 3 based on the Health Criteria H.

The majority of samples will be in Class 1, which draws less attention during maintenance schedules. It should have high accuracy to ensure that no abnormal sample is falsely classified in this class. Therefore, both machine learning model and signal processing technique with health criteria are used to classify the samples as Class 1 for better accuracy. For samples that are classified as abnormal by the machine learning model, they will be further classified into Class 2 to Class 3 based on Health Criteria H shown in equation (1). The probability of failure can also be determined.

The circuit breaker 104 is in a normal state when the HI is in Class 1. The circuit breaker 104 exhibits degradation and requires special attention when the HI is in Class 2. When the HI is in Class 3, the circuit breaker is in poor health condition, and immediate actions such as ad hoc repair or maintenance are required to prevent further degradation or failure of the circuit breaker 104.

The circuit breaker health monitoring system 108 as shown in FIG. 1 can also further communicate with other data sources, including but not limited to the event log server 120 to determine the circuit breaker 104 ID of the diagnosed signals. The trip coil waveform data capture system 106 and circuit breaker health monitoring system 108 are connected by a network device, such as an Ethernet switch 118, and to the other data sources. The circuit breaker 104 anomaly diagnosis system in the present invention will then send an alert message if any anomaly is detected. A user interface 116 is provided for users to browse data in the system.

As shown in FIG. 4, the prediction of RUL is obtained by following the increase in trend of health criteria and setting the threshold. An alert message, such as SMS, email, etc., is automatically sent to the engineer when a poor health index is detected, providing an early warning before circuit breaker 104 failure.

FIG. 5 illustrates an example method flowchart of detecting health conditions for circuit breaker 104 system in the present invention. The tripping of the circuit breaker 502 triggers the trip coil waveform data capture system 106 to collect the trip coil 206 current profile. The method of detecting health conditions comprises creating trip coil 206 current profile data 504, communicating with the event log server 120 and conducting profile data matching 506 with the corresponding circuit breaker 104 ID when there is no circuit breaker 104 ID from the trip coil waveform data capture system 106. The method further comprises sending signals to the circuit breaker health monitoring system 108, conducting analysis by signal processing algorithms 112 that include signal filtering 508, smoothing and feature extraction. Further, the data are analyzed by the machine learning algorithm for health diagnosis. The system then automatically sends an alert message to user 510, such as engineers, if the diagnostic result by the algorithms is abnormal, while recording the result as historical data for trend analysis 512 if the diagnostic result by the algorithms is normal.

The present invention explained above is not limited to the aforementioned embodiment and drawings, and it will be obvious to those having an ordinary skill in the art of the prevent invention that various replacements, deformations, and changes may be made without departing from the scope of the invention.

1. A method for anomaly detection, health index classification, and remaining useful life (RUL) prediction of circuit breakers, comprising the steps of:
capturing and collecting real-time trip coil waveform signals from each of circuit breakers;
transmitting the collected trip coil waveform signals to a circuit breaker health monitoring system;
processing the collected signals data;
analyzing the processed data using artificial intelligence and signal processing algorithms for anomaly detection, health index classification, and remaining useful life (RUL) prediction of circuit breakers;
storing data;
performing trend analysis on data; and
predicting remaining useful life (RUL).

2. The method for anomaly detection, health index classification, and remaining useful life (RUL) prediction of circuit breakers, according to claim 1, wherein analyzing of the processed data using artificial intelligence comprises the steps of:
training and developing an unsupervised machine learning model using trip coil waveforms of the circuit breakers; and
identifying anomalies in waveforms.

3. The method for anomaly detection, health index classification, and remaining useful life (RUL) prediction of circuit breakers, according to claim 1, wherein the analyzing of the processed data using signal processing algorithms comprises the steps of:
filtering and smoothing signal; and
extracting features for health diagnosis and health criteria calculation.

4. The method for anomaly detection, health index classification, and remaining useful life (RUL) prediction of circuit breakers, according to claim 2, wherein the method further comprises the steps of:
providing simultaneous multi-level health index classification; and
automatically sending an alert message to a user when an anomaly of a circuit breaker is detected for facilitating prompt follow-up actions.

5. The method for anomaly detection, health index classification, and remaining useful life (RUL) prediction of circuit breakers, according to claim 2, wherein the identifying of anomalies in waveforms comprises the steps of:
recording result as historical data for trend analysis of the circuit breakers;
setting the threshold for end of life (EOL); and
predicting remaining useful life (RUL) of circuit breakers.

6. The method for anomaly detection, health index classification, and remaining useful life (RUL) prediction of circuit breakers, according to claim 1, wherein the method further comprises the step of:
online monitoring and centralizing the collected signals data, data analysis and data storage in the circuit breaker health monitoring system.

7. The method for anomaly detection, health index classification, and remaining useful life (RUL) prediction of circuit breakers, according to claim 6, wherein the method further comprises the step of storing data in a server, including but not limited to a local or cloud server.

8. The method for anomaly detection, health index classification, and remaining useful life (RUL) prediction of circuit breakers, according to claim 1, wherein the method further comprises the step of:
communicating with other data sources, including but not limited to an event log server for determining the identity of the circuit breaker associated with diagnosed signals.

9. A circuit breaker anomaly diagnosis system comprising:
a power distribution system with circuit breakers that is deployed with:
a data acquisition module configured to collect real-time trip coil waveform signals from each of the circuit breakers;
a processing module;
a monitoring module, deployed with an artificial intelligence and signal processing algorithms; and
a storage module.

10. The circuit breaker anomaly diagnosis system, according to claim 9, wherein the data acquisition module comprises trip coil waveform data capture system.

11. The circuit breaker anomaly diagnosis system, according to claim 10, wherein the trip coil waveform data capture system comprises current probes, oscilloscopes, and microcontrollers.

12. The circuit breaker anomaly diagnosis system, according to claim 9, wherein the monitoring module comprises circuit breaker health monitoring system that is configured to perform data analysis and data storage.

13. The circuit breaker anomaly diagnosis system, according to claim 12, wherein the circuit breaker health monitoring system is a cloud-based, online and centralized system that is configured to monitor the health and performance of circuit breakers located in various locations and enable real-time data transmission to the cloud.

14. The circuit breaker anomaly diagnosis system, according to claim 9, wherein the artificial intelligence comprises unsupervised machine learning models.

15. The circuit breaker anomaly diagnosis system, according to claim 14, wherein the unsupervised machine learning model is developed and trained using the entire trip coil waveforms of the circuit breakers to identify anomalies in waveforms.

16. The circuit breaker anomaly diagnosis system, according to claim 9, wherein the signal processing algorithms are configured to analyze the features of the trip coil current waveforms, diagnose the health conditions of circuit breakers and determine the health index of circuit breakers.

17. The circuit breaker anomaly diagnosis system, according to claim 16, wherein the signal processing algorithms are further configured to provide simultaneous multi-level health index classification.

18. The circuit breaker anomaly diagnosis system, according to claim 9, wherein the storage module is configured to record result as historical data for trend analysis.

19. The circuit breaker anomaly diagnosis system, according to claim 9, wherein the system is configured to predict remaining useful life (RUL) of the circuit breakers.
